(19) United States
(12) Patent Application Publication
(10) Pub. No.: US 2004/0011296 A1
(43) Pub. Date: Jan. 22, 2004

(54) Animal activated dispensing device

(76) Inventor: Bert F. Quin, Auckland (NZ)

Correspondence Address: YOUNG & THOMPSON, 745 SOUTH 23RD STREET 2ND FLOOR, ARLINGTON, VA, 22202

(21) Appl. No.: 10/380,004

(22) PCT Filed: Sep. 11, 2001
(86) PCT No.: PCT/NZ01/00190

(30) Foreign Application Priority Data
Sep. 11, 2000 (NZ) 506883

(51) Int. Cl. A01K 29/00

(52) U.S. Cl. 119/161

(57) ABSTRACT

A dispensing device including: A reservoir means (11) and to contain a flowable substance; An opening (19) in the reservoir to allow the flowable to enter or exit the reservoir (11); A valve means (15) to allow the flowable substance to enter or exit the reservoir (11); Retention means (6) to retain the device on an animal (4); and, The arrangement and construction being such that the valve means (15) releases the flowable substance in response to the animal (4) urinating or like to urinate.

### FIELD OF INVENTION

The present invention relates to a dispensing device.

### BACKGROUND OF INVENTION

Nitrogen is an essential nutrient in fertilizers and soils for the growth of pastures. Nitrogen is also a significant constituent in the urine of dairy cows and is therefore returned or recycled to pastures when cows urinate. Once an area of pasture is soaked in the urine of a cow, the nitrogen in the urine, most of which is present as urea, transforms very quickly into ammonium-nitrogen and then into nitrate-nitrogen which leaches out of the soil very quickly. In addition, much of the ammonium-nitrogen can be converted to greenhouse gases, ammonia and nitrous oxide. As a consequence of that, there is a huge loss of nitrogen from fertilizers in New Zealand, typically in the range of 20-100 kilograms per hectare annually.

A number of methods have been contemplated by biological scientists to minimise these losses of nitrogen. These methods include devices to spread the urine over a large area of the pasture, breeding cows with smaller bladders so that they urinate more frequently (and therefore over a larger total area), and producing grasses, clovers and other feeds that contain less nitrogen so that a smaller amount of nitrogen is consumed by cows. None of these methods has yet proved to be a practical method of overcoming the problem.

A feasible way of overcoming the problem is to spread an environmental friendly nitrification inhibitor, such as ammonium thiosulphate or a urease inhibitor on pastures. The main function of a nitrification inhibitor is to slow down the rate of transformation of ammonium-nitrogen to nitrate-nitrogen. A urease inhibitor reduces the rate at which urea converts to ammonium nitrogen. Either way pastures would have more time to absorb the nitrogen in the urine before the nitrogen is transformed to nitrate, which will then leach out of the soil very quickly. Although spreading a nitrification inhibitor on pastures is feasible in theory, the problem in practice is that it is not economical or practical to spread an inhibitor over large pasture areas. Clearly, the only efficient way of spreading such an inhibitor is to place it at locations where a cow has actually urinated, or a location where a cow is just about to urinate so that the inhibitor can act upon the nitrogen containing components of the urine. This in turn presents practical difficulties.

### OBJECT OF THE INVENTION

It is an object of the present invention to provide a dispensing device or method which will at least go some way toward overcoming disadvantages associated with the prior art, or which will at least provide the public with a useful choice.

### SUMMARY OF THE INVENTION

Accordingly in one aspect the present invention may broadly be said to consist in a dispensing device including

a reservoir means adapted and to contain a flowable substance;

an opening in the reservoir to allow the flowable substance to enter or exit the reservoir;

a valve means to allow the flowable substance to enter or exit the reservoir through the opening;

retention means to retain the device on an animal;

and the arrangement and construction being such that the valve means releases the flowable substance in response to the animal urinating or being likely to urinate.

In a further aspect the invention may broadly be set to consist in a method for dispensing a flowable substance in or adjacent to an area where an animal urinates or is likely to urinate, the method comprising the steps of

providing a reservoir containing a flowable substance,

attaching the reservoir to the animal,

sensing when an animal urinates or is likely to urinate, and

dispensing the flowable substance from the reservoir in or adjacent to the area where the animal has urinated or is likely to urinate.

The invention may also broadly be said to consist in the parts, elements and features referred to or indicated in the specification of the application, individually or collectively, and any or all combinations of any two or more of the said parts, elements or features, and where elements or features are mentioned herein and which have known equivalents in the art to which this invention relates, such known equivalents are deemed to be incorporated herein as if individually set forth.

The invention consists of the forgoing and also envisages constructions of which the following gives examples.

### DRAWING DESCRIPTION

One preferred form of the present invention will now be described with reference to the accompanying drawings in which;

FIG. 1 is a diagrammatic side view of a dispensing device in accordance with the present invention provided on the tail of a dairy cow with the tail in the lowered position.

FIG. 2 is a diagrammatic side elevation in cross section of the device of FIG. 1.

FIG. 3 is an end view of the device of FIG. 1.

FIG. 4 is a further side view of the device of FIG. 1 in use provided on a tail of a dairy cow with the tail in a raised position.

### DETAILED DESCRIPTION

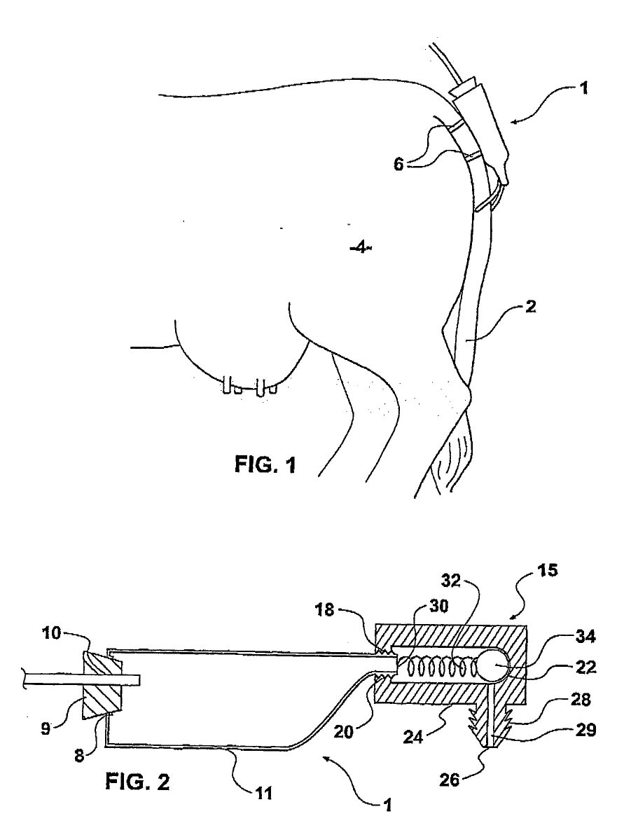

Referring to FIG. 1, a dispensing device in accordance with one embodiment of the present invention, generally referenced 1 is shown located about a tail 2 of a dairy cow 4. The tail 2 is in a generally vertical or upright position and the device 1 is also in a generally upright position. Straps 6 are provided in use to secure the device 1 to the cow. It is also contemplated that the device may be secured to other parts of the body such as the back, abdomen or leg(s), or be secured to other apparatus which is fastened onto the cow 4 for example being attached to a form of saddle harness, or the like. The straps 6 could also be replaced with resilient or elastic members designed to hold the device in a desired position on the animal.

Referring now to FIG. 2, the dispensing device 1 is shown in more detail in a substantially horizontal position. The device 1, at least in the presently preferred form, is shown in more detail includes an inlet 8 which has a stopper 9 that comprises a bung for example. A reservoir or enclosure 11 is provided having an outlet means 14.

In the preferred embodiment the device 1 dispenses a liquid, since the substance intended to be dispensed by the device is often provided in liquid form, as described further below. However, it will be appreciated that the device could dispense other flowable substances, for example solids and powder, granular or sprayable form.

An aperture 10 is provided in the centre of the stopper 9. A conduit 12 is received through the aperture 10 of the inlet 9 leading to the reservoir 11. In use the stopper 9 may be removed to fill the reservoir 11 with a liquid or other flowable substance. The stopper 9 may be a simple bung that makes a frictional engagement with the walls surrounding inlet 8, or could make a threaded engagement or be a “click fit” for example. The conduit 12 is provided to allow air to enter the reservoir 11 as the substance in the reservoir leaves the device through the outlet. This assists flow. Optionally, the conduit 12 may be used by a user to fill the liquid dispensing device. In use, chemical solutions that have urease or nitrification inhibiting properties, are placed in the reservoir 11. Once the reservoir has been filled with a desired volume of the substance to be dispensed, the stopper 9 is then engaged with the walls of the reservoir adjacent to inlet 8 so that a seal is made between the stopper and the reservoir walls. It is also contemplated that other devices or designs such as a shutter or one way valve arrangement may also be used to allow solution and air to enter the inlet 8 but substantially prevent chemical solution from flowing but out of the inlet 8.

The reservoir 11 is preferably of a shape adapted for location on a part of the tail of an animal such as a dairy cow, and defines an enclosure to contain the chemical solution. The end of the reservoir 11 opposite inlet 8 has annular outlet which is externally threaded at 18 so that it may be screwed onto an internal thread 20 of a valve housing 15.

The housing 15 is also preferably annular in shape and consists of a front opening 19 with a threaded portion 20 at one end, an internal semi-spherical seat 22 designed for a ball-bearing to reside at the other closed end, and an annular channel intermediate section 24. In use, the valve housing 15 is in fluid communication with the reservoir 11. The valve housing 15 further includes an outlet spout 26 which extends from, and substantially perpendicular to the housing 15. The exterior of the spout 26 is provided with upwardly wedging steps 28 to facilitate engagement with a flexible tube or the like if desired. A channel 29 is provided in the interior of the spout 26 opening to the interior of housing 15 adjacent to the valve seat 22. Abutting a flat annular end surface 30 of the reservoir 12 is one end of a spring 32. A ball-bearing 34 is provided at the other end of spring 32. When the outlet means 14 is screwed endwise on to the reservoir means 12, the spring 32 maintains a gentle force against the ball-bearing to prevent it from travelling too far away from the semi-spherical seat 22 when the device is in a substantially horizontal position. When the device is in a substantially vertical position, the ball-bearing stops the chemical solution from flowing out of the reservoir 11 by moving into contact with the seat 22, thus blocking the channel 29 of the spout 26.

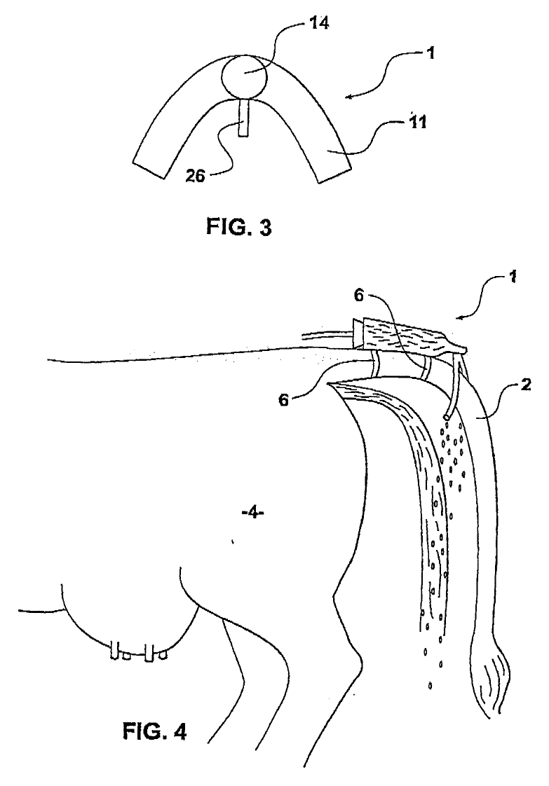

Referring now to FIG. 3, an end view of the liquid dispensing device is shown. The body of the reservoir 12 is provided so as to be convex in shape to thus conform to the shape of the tail of the cow 4 as shown in FIG. 1. The reservoir 12 may be formed to various dimensions which are designed to contain a volume of chemical solution preferably in the range of 80-150 ml. Also, the device is preferably formed of a lightweight plastic so that the cow can raise its tail with ease and which enables the device to be manufactured easily and inexpensively. The spout 26 is preferably dimensioned, and the flow is preferably adjustable, to allow about 20 ml of chemical solution to flow out in 10 to 30 seconds, which is a typical urination period of a cow.

The preferred urease inhibitor for use with the present invention is a solution of the phosphoromide nBTPT (N-n-butyl) thiophosphoric triamide. The solution containing a concentrate of approximately 30% by weight of nBTPT has been found to provide satisfactory results with use of the dispensed volumes referred to above. It will be understood that other substitutes or alternative urease or nitrification inhibiting solutions may be used. Also, as mentioned previously, the inhibitor does not need to be provided in a liquid form as it could be provided in the form of pellets for example or granules. Although this would necessitate some changes to the preferred embodiment discussed herein, it will be understood to one skilled in the art that appropriate modifications could be made to the valve assembly of the apparatus to enable a granular substance to be released. Similarly, an inhibitor could be provided in a powder form which could be dispensed by spraying under pressure for example.

Turning now to FIG. 4, in use, the reservoir means 12 disposed in a substantially horizontal position is demonstrated when the tail 2 of the cow 4 is raised in a fashion to dispense the chemical solution from the spout 16 in the course of urination. Invariably, a cow will raise its tail to urinate. What happens is that the ball-bearing 34 will gently roll backwards towards the reservoir means 12 due to gravitational force, although its motion will be stopped at some stage by the spring 32, which acts as a suspension and supporting device. The chemical solution will then be allowed to flow from the reservoir 11 through the valve housing 15 and through the spout 26 to fall on the pasture on or adjacent to the area where the cow urinates or is likely to urinate. After the cow 4 finishes urinating, its tail 2 will fall back to the original or ordinary position. Consequently, the ball bearing will restore to its seat 22 at the bottom end of the housing 15, which will subsequently stop the chemical solution from flowing out of the spout 26.

It will be seen that a number of different dispenser arrangements and valve arrangements may be used to implement the invention. In particular, the valve need not be limited to actuation by gravity i.e. there could be a level sensing device that senses the orientation of the tail of the animal and actuates the valve electrically, or pneumatically, or by some other means. Furthermore, rather than level sensing, the device may include a urine sensor i.e. a device which senses when urine flow is occurring, and actuates the valve accordingly. This may be necessary if the device is not attached to the tail of the animal. The device may also include a timer, for a timed valve actuation of predetermined duration.

It will also be seen that the invention is not limited to use with dairy animals. The invention is applicable to any situation where it is desirable to add a substance to the waste products of an animal.

As described above, one preferred solution that may be dispensed in accordance with the invention to reduce the rate of urea transformation is nBTPT, however other compositions or solutions may be used.

The reservoir is preferably made from a transparent plastic material so that the quantity of substance in the reservoir can be observed. It will be seen that the substance may be provided in any flowable form, and could be provided in the reservoir under pressure if desired.

The present invention envisages that a time-delay of say 5 seconds to be built in (either mechanically, electrically or pneumatically), so that no urease or nitrification inhibitor is dispensed (and therefore partially wasted), during the shorter-interval excreting activities of cows which usually also involve the animal raising its tail.

Several advantages over prior art are apparent. The importance of these advantages stem from the mobility and automation of the current invention. Firstly, since the liquid dispensing device is fastened onto a cow, it can function as a mobile dispenser where ever the cow goes. Secondly, as the liquid dispensing device is activated by the tail of the cow, no manual procedures or operations are required in the process of irrigating pastures except periodic refills with chemical solutions such as ammonium thiosulphate in the present case. Hence, although known watering cans can be used, there is no comparison to the convenience and portability offered by the current invention. Last but not least, consumption of the chemical solution can be reduced significantly by utilising the liquid dispensing device. The reason for this is because instead of having to apply the chemical solution all over a pasture or in specific patches, it can merely be applied locally to wherever the cow urinates.

1. A dispensing device including
a reservoir means adapted to contain a flowable substance,
an opening in the reservoir to allow the flowable substance to enter or exit the reservoir,
a valve means to allow the flowable substance to enter or exit the reservoir through the opening,
retention means to retain the device on an animal, and
the arrangement and construction being such that the valve means releases the flowable substance in response to the animal urinating or being likely to urinate.

2. A dispensing device as claimed in claim 1, wherein the valve means comprises a valve member and a valve seat, the valve seat being provided adjacent to the opening and the valve member comprising a moveable member which is moveable between a substantially closed position in which the valve member makes a substantial seal in contact with the valve seat, and an open position where the valve member is not in sealing contact with the valve seat.

3. A dispensing device as claimed in claim 1 or claim 2, wherein the opening comprises an outlet, and a separate inlet is provided for filing the reservoir.

4. A dispensing device as claimed in any one of the preceding claims, wherein an air inlet is provided.

5. A dispensing device as claimed in any one of the preceding claims, wherein the inlet includes a removable stopper and the air inlet is provided within the stopper.

6. A dispensing device as claimed in any one of the preceding claims, wherein the device is constructed in shape so as to be locatable on or about the tail of an animal such as a dairy cow.

7. A dispensing device as claimed in any one of the preceding claims, wherein the reservoir means is constructed from a substantially transparent material.

8. A dispensing device as claimed in claim 1, wherein the valve means is electrically operable.

9. A dispensing device as claimed in claim 1, wherein the valve means is pneumatically operable.

10. A dispensing device as claimed in any one of the preceding claims including a time delay means to provide a delay between an indication that the animal is about to urinate and the release of the valve means.

11. A dispensing device as claimed in any one of the preceding claims, wherein the retention means comprises one or more straps.

12. A method for dispensing a flowable substance in or adjacent to an area where an animal urinates or is likely to urinate, the method comprising the steps of
providing a reservoir containing a flowable substance,
attaching the reservoir to the animal,
sensing when the animal urinates or is likely to urinate, and
dispensing the flowable substance from the reservoir in or adjacent to the area where the animal has urinated or is likely to urinate.

13. A method as claimed in claim 12, wherein the step of sensing when the animal urinates or is likely to urinate includes the step of sensing when the animal raises its tail.

14. A method as claimed in claim 12, wherein the method of sensing when the animal urinates or is likely to urinate includes the step of sensing urine flow from the animal.

15. A method as claimed in claim 12, wherein the step of sensing when the animal urinates or is likely to urinate includes the step of sensing the sound of the urine flow.

16. Any novel feature or combination of features or method steps disclosed herein.
